(19) United States
(12) Patent Application Publication
(10) Pub. No.: US 2014/0123100 A1
(43) Pub. Date: May 1, 2014

(54) SYSTEM AND METHOD FOR IMPLEMENTING INFORMATION SYSTEMS

(71) Applicant: JUMP SOFT A.S., Bratislava (SK)

(72) Inventor: Radovan Brecka, Bratislava (SK)

(73) Assignee: JUMP SOFT A.S., Bratislava (SK)

(21) Appl. No.: 13/663,181

(22) Filed: Oct. 29, 2012

(51) Int. Cl. G06F 9/44

(52) U.S. Cl. 717/101

(57) ABSTRACT

A system and method for creating transparent and easily maintainable information systems is implemented through a configuration oriented programming paradigm. The information system is implemented by identifying specific needs in a top-down Analysis phase and directly mapping them to a Configuration of the information system in a similar top-down approach.

### FIELD OF THE INVENTION

This invention relates generally to a system and method for implementing information systems on computer processors and/or systems. More specifically, this invention relates to the creation of information systems using configuration oriented programming.

### BACKGROUND OF THE INVENTION

The most common current method of developing information systems is through Object-oriented programming (“OOP”), including any modifications and extensions thereof, such as Service-oriented architecture (“SOA”) and Aspect-oriented programming Object-oriented programming languages include Java, C#, C++, and other similar programming languages. These information systems are generally implemented in four phases: 1) Analysis, 2) Design, 3) Implementation, and 4) Testing.

This four-phase methodology and the resulting information system may appear clear and transparent, but routine practice has shown that clarity and transparency are quite limited and significant problems exist. One of the biggest troubles is late identification of a possible bug or error. As used herein, the term “bug” refers to any undesired functionality of the information system. If the required function is incorrectly identified during the Analysis phase, then this bug will show only at the end when the information system has been implemented. Additionally, bugs in any step may not appear until the Testing phase. Whenever a bug is discovered, which typically only happens in later phases of the four-phase methodology, it is very often necessary to rework one or more prior phases in order to correct the bug. This rework, while fixing the bug, may create further clarity and transparency problems.

For at least one or more of these reasons, new methods of information system creation were devised. One example may be the Iteration-incrimination information system creation method (e.g., Rational-Unified Process (“RUP”) or Rapid application development/Agile). Even with these new information system creation methods, the analysis, design, implementation and testing phases can be identified (these phases are absolutely transparent in RUP, while in Extreme programming they are less clear but still identifiable).

An important milestone in the creation of these methods was the construction of a Unified model language (UML) allowing efficient information exchange between the four phases. This language can precisely define how the functions and concepts shall be laid down in the Analysis phase (e.g., through conceptual diagrams), how architecture shall be defined in the Design phase (e.g., through class diagrams, behavioral diagrams: sequence, activity, collaboration), and how the information system shall be Implemented (e.g., through deployment diagrams). In order for an information system to be clearly created while using UML, information system creators must strictly adhere to UML, which may increase the time and effort necessary to create the information system.

Even though clear information system creation methodologies and practices exist, it must be noted that the current implementation methods are based on the principles of Object-oriented programming which were first published in 1967 in the Simula 67 language. Evidence of the ongoing difficulties with current programming methods is shown in the development of new programming languages (such as Ruby, Erlang, Go, etc.) and the creation of new programming techniques (such as Aspect-oriented programming, Meta programming and the like).

Accordingly, amongst other needs present in current information system creation methodologies, there is a need for an information system creation methodology that is capable of full information system creation through a top-down approach that coincides with the top-down analysis of that information system's specific needs.

### SUMMARY OF THE INVENTION

The invention relates to various exemplary embodiments, including systems, platforms, environments, and methods of using the same.

These and other features and advantages of the invention are described below with reference to the accompanying drawings.

### BRIEF DESCRIPTION OF THE DRAWINGS

FIG. 1 is a schematic representation of a prior art method of information system creation.

FIG. 2 is a schematic representation of the system and method of information system creation according to the present invention showing the mapping of specific needs from an Analysis Phase to Configuration Nodes.

FIG. 3 is a schematic representation of the system and method of information system creation according to the present invention showing the absence of a standard design phase.

FIG. 4a is a schematic representation of a prior art imperative programming method of information system creation (e.g., BASIC, assembly).

FIG. 4b is a schematic representation of a prior art structured programming method of information system creation (e.g., pascal, C).

FIG. 4c is a schematic representation of a prior art objected oriented programming method of information system creation (e.g., C++, C#, Java).

FIG. 4d is a schematic representation of an embodiment of the system and method of information system creation according to the present invention using configuration oriented programming.

FIG. 5 is a schematic representation of the system and method of information system creation according to the present invention showing the mapping of specific needs from an Analysis Phase to Configuration Nodes.

FIG. 6 is a schematic representation of a Configuration of a Book Records Information System.

FIG. 7 is a visual representation of the Configuration Nodes and Node Types of a Book Records Information System.

FIG. 8 is a schematic representation of a modified Configuration of a Book Records Information System.

FIG. 9 is a visual representation of the modified Configuration Nodes and Node Types of a Book Records Information System.

FIG. 10 is a schematic representation of an embodiment of a system architecture of the system and method of information system creation according to the present invention.

FIG. 11 is a schematic representation of an embodiment of a system architecture of the system and method of information system creation according to the present invention.

FIG. 12a is a schematic representation of a Configuration as processed in the disclosed system and method of information system creation according to the present invention.

FIG. 12b is an alternate schematic representation of the Configuration of FIG. 12a, as processed in the system and method of information system creation according to the present invention.

FIG. 13 is a visual and schematic representation of the Platform of the system and method of information system creation according to the present invention.

FIG. 14 is a schematic representation of the View Layer of the Platform of the system and method of information system creation according to the present invention.

FIG. 15 is a schematic representation of the Security Layer of the Platform of the system and method of information system creation according to the present invention.

FIG. 16 is a schematic representation of the Unit Test Process of the Platform of the system and method of information system creation according to the present invention.

FIG. 17a is a schematic representation of an information system implemented using the Platform of the system and method of information system creation according to the present invention, including a Project Configuration, a Project Programming, and a Platform Core.

FIG. 17b is a schematic representation of an embodiment of the exemplary information system implemented using the Platform of the system and method of information system creation according to the present invention.

FIG. 18 is a visual and schematic representation of the Platform of the system and method of information system creation showing a Code Configuration and a Project Configuration according to the present invention.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Reference numerals are used throughout this disclosure to indicate various elements depicted in the accompanying Figures. It shall be understood that reference numerals as present on each accompanying Figures represents at least some, but not necessarily all of the associated elements shown in that particular Figure. In other words, in a Figure showing many instances of a particular element, the reference numeral for that element may only point to one or a few of that particular element and not every instance of that particular element within the Figure. This abbreviated use of reference numerals is to increase the readability and legibility of the accompany Figures and shall not be considered to limit the disclosure herein.

### SYSTEM AND METHOD FOR CREATING INFORMATION SYSTEMS

Disclosed is a system and method for creating information systems through the direct mapping of analysis concepts on the configuration of an information system implemented through configuration-oriented programming.

As used herein, the term “top-down” refers to an approach wherein the more general aspects of an information system are considered before considering the more specific and detailed aspects of an information system. The term “bottom-up” refers to an approach wherein the specific and detailed aspects of an information system are considered first, before considering the more general aspects of an information system.

As used herein, the term “information system” may refer to any system used to manage data. Typically, an information system may be a computer program.

As used herein, the term “data storage device” refers to any device capable of storing data, including but not limited to hard drives, solid state memory, removable memory (e.g., CDs, floppy disks, tapes), and other such devices. As used herein, the term “data storage unit” refers to a portion of memory of any size within a data storage device. It is to be understood that a discrete file or collection of files may be located in a single data storage unit, regardless of the number of or size of the file(s). For example, a folder of files as seen on a Graphical User Interface of a standard desktop computer may be considered as being located in a single data storage unit (i.e., portion of memory) within a data storage device (e.g., hard drive). It will be further understood that a storage device may be located remote to any processor used to access that device. For example, a user in a first location may use a computer to access a data storage unit within a data storage device housed in a second location via remote communication. Remote communication may include any form of electric or electromagnetic transmission, such as using a processor to access another processor through the internet or through a local network.

As used herein, the term “environment for implementing an information system” includes a system or collection of systems designed to implement or run an information system. For example, such an environment may be a computer loaded with the Platform described herein and capable of implementing information systems using the system and method of the present invention. Additionally, an example of such an environment may include a computer running an information system that has been implemented using the system and method of the present invention.

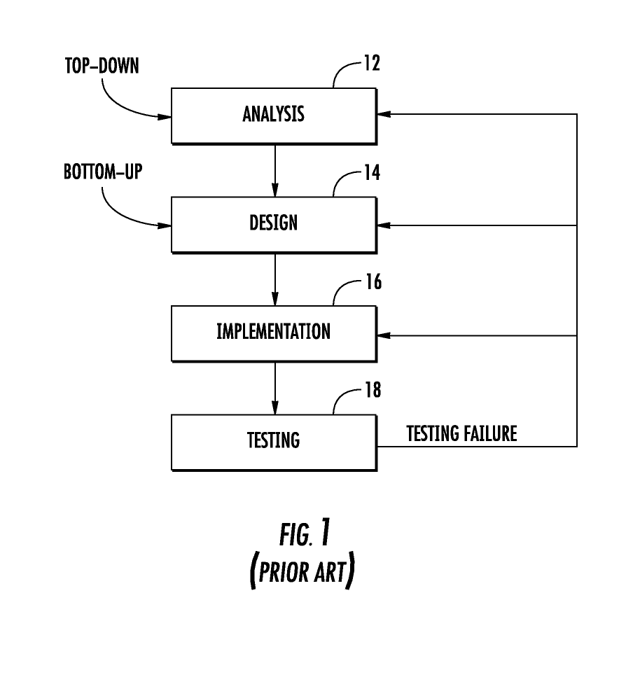

Referring to FIG. 1, the four phases of a prior art method of developing information systems are shown.

In the Analysis phase 12, information is collected regarding the desired properties of the desired information system. Through a top-down approach, the requirements on the desired information system are determined by specifying abstract concepts.

In the Design phase 14, the architecture of the desired information system is designed based on the specified needs identified in the Analysis phase. Through a bottom-up approach, the objects necessary to implement the future architecture are proposed and planned. In the example of an information system prepared in OOP, the Design phase 14 may result in the planning of the various classes required by the information system and their structure in relation to the full project.

In the Implementation phase 16, the desired information system is created and programmed based on the specified needs identified in the Analysis phase and the planned architecture prepared in the Design phase. In the example of an information system prepared in OOP, the Implementation phase 16 may result in the coding process necessary to implement the classes identified in the Design phase 14, as well as implement the full structure of the information system.

In the Testing phase 18, the information system is checked for compliance with the specified needs identified in the Analysis phase. If the testing fails (i.e., the system does not operate as desired), one or more phases may need to be repeated. Often, the process must restart from the design phase 14, resulting in the repeating of both the design phase 14 and implementation phase 16 for at least that portion of the information system that did not pass the testing phase 18. In some cases, the process may need to restart from the Analysis phase 12, resulting in the repeating of all phases over again for at least that portion of the information system that did not pass the testing phase 18. In some cases, even portions of the information system that did pass the testing phase may need to be rewritten in order to continue operating as expected after other portions of the information system that did not pass the testing phase are rewritten.

Configuration-oriented programming (“COP”) has presented new options for implementing new information systems. An important distinction between COP and Object-oriented programming (“OOP”) is the introduction of the configuration dimension directly into Object-oriented programming The new configuration dimension introduces a new point of view through a configuration form that enables the use of inheritance, abstraction, polymorphism, and recursive definition on the Configuration itself. This new configuration dimension enables new methods and systems for developing information systems.

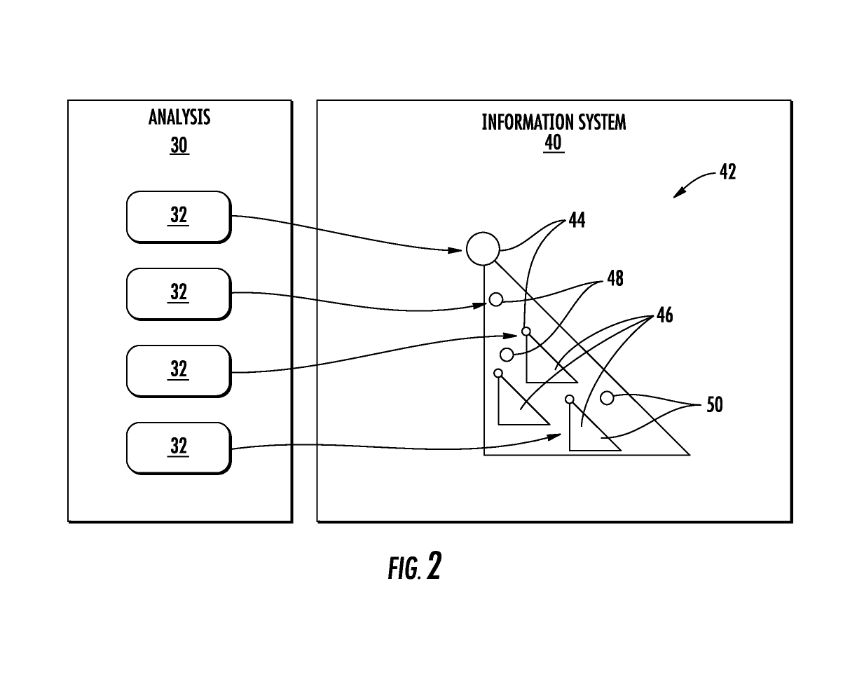

Referring to FIG. 2, an information system 40 comprises at least one configuration 42. The configuration 42 includes at least one top module 44. A configuration 42 can theoretically exist with only a single top module 44 and no other configuration nodes 50. However, in practice, the configuration 42 may include one or more additional configurations 46, and/or one or more additional modules 48. Each additional configuration 46 may contain similar elements as that of configuration 42 (e.g., at least one top module and optionally, one or more additional configurations, and/or one or more additional modules). As shown in FIG. 2, any additional configuration 46 will have its own top module 44. Every module 44, 48 and additional configuration 46 within a configuration 42 shall be considered a configuration node 50. Each configuration node 50 may have one or more operations. Each configuration node 50 may represent a business object (e.g., a physical object for which data must be tracked). Configuration nodes 50 may be unique or shared between many different projects or systems. As used herein, the term “module” may be inclusive of the term “configuration,” depending upon context.

As shown in FIG. 2, an Analysis phase 30 may result in the identification of one or more specification needs 32. As used herein, the term “specification need” refers to a desired aspect of an information system (e.g., ability to print a page; ability to track a quantity of an object; or ability to ability to display time of day). In some instances, a specification need may be a physical object, an aspect of a physical object, or a relationship between a plurality of physical objects. For example, a specification need may be a business resource that must be tracked, such as a conference room. In another example, a specification need may be a business resource for which an aspect of it must be tracked, such as the seating capacity of a conference room. In yet another example, the specification need may be a relationship between physical objects that must be tracked, such as a “belonging to” relationship as in the case of a chair “belonging to” a conference room. Any physical object, aspect of a physical object, or relationship between physical objects, as used herein, may include trackable data. For example, the conference room may contain data such as its dimensions and abilities (e.g., projector screen). In another example, the seating capacity of a conference room may contain data in the form of numbers of people. In yet another example, the relationship of the chairs to the conference room may contain data in the form of text information (e.g., description of where the chair belongs in the room).

These specification needs 32 are identified in a top-down approach. In other words, more general aspects (e.g., general ability to track books in a library) are identified first before the more specific aspects (e.g., specific ability to add a book to the list of those being tracked) are identified.

These specification needs 32 may then be mapped directly on the configuration modules 44, 48 or to configurations 42, 46 themselves. As used herein, “mapping” a specification need to a Configuration refers to assigning a specification need 32 to a configuration node 50 within a configuration 42. In other words, an identified specification need 32 may be fulfilled by a configuration node 50. Generally, in a mapping known as one-to-one mapping, a single specification need 32 is mapped to a single configuration node 50. In a mapping known as many-to-one mapping, a number of specification needs 32 are mapped to a single configuration node 50. In a mapping known as one-to-many mapping, a specification needs 32 is mapped to a number of configuration nodes 50. In some instances, the specification needs 32 may be mapped directly on the configuration nodes 50 in a one-to-one mapping or a many-to-one or one-to-many mapping. It will be understood by those having skill in the art that various combinations of one or more specification needs 32 may be mapped to one or more configuration nodes 50.

In some instances, not every specification need 32 must be mapped in order for the information system 40 to function as desired. Through this mapping process, an information system 40 may be programmed in a top-down approach, analogously to the Analysis phase 30 that results in the specification needs 32 required of the information system 40. It will be noted that this mapping process does not require significant technical knowledge in how to write code, but rather only requires a basic knowledge of how to manipulate a configuration 42.

As part of the mapping process, each configuration node 50 may be assigned a node type. The node type defines how that configuration node 50 operates. A further description of node types is described below.

The specification needs 32 may be mapped to configuration nodes 50 in a one-to-one relationship. When a configuration 42 has been constructed by mapping a specification need 32 to a configuration node 50, the functionality required by the specification need 32 is implemented by the respective modules 44, 48. The entire information system 40 is implemented in this fashion based on the specification needs 32 outlined in the Analysis phase 30.

By mapping the results of the Analysis phase 30 directly onto the configuration 42 that implements information system 40, the design phase 14 may be either eliminated or significantly reduced. Additionally, by mapping the results of the Analysis phase 30 directly onto the configuration 42, the resulting information system 40 has a structured architecture that enables better clarity and transparency in the final information system (i.e., the information system architecture need not be laid down through UML diagrams). Also, due at least to its clear and transparent architecture, maintenance and operation of the information system 40 implemented in this way is significantly easier. For example, someone hired to update the information system 40 who was not involved in its creation would be able to easily and quickly determine how the information system 40 operates and would be able to update specific parts of the information system 40 as necessary without resorting to reading extensive documentation, without communicating with creators of the information system 40, and without dredging through every line of code of the information system 40.

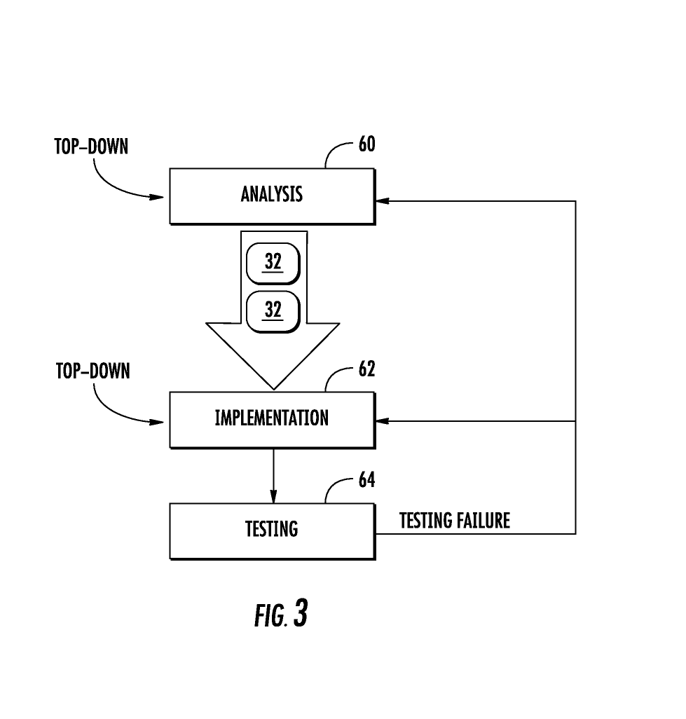

As shown in FIG. 3, using the method and system of the present invention for implementing COP, the specification needs 32 from the Analysis phase 60 are passed directly to the Implementation phase 62. This Implementation phase 62 is the mapping process described above. By mapping the specification needs 32 directly to the configuration during the Implementation phase 62, the need for the design phase is significantly lower and the Implementation phase 62 is able to progress in a top-down fashion. It will be noted that, in contrast to the prior art method depicted in FIG. 1, the disclosed method and system for implementing COP, as shown in FIG. 3, requires no bottom-up phases.

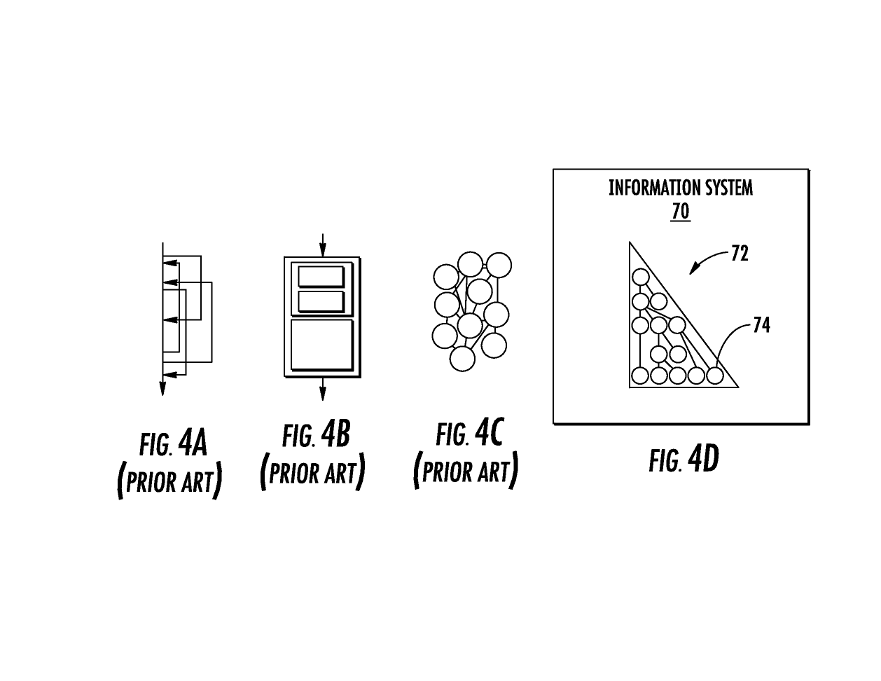

Referring to FIGS. 4a-4d, information systems programmed using various programming paradigms are shown. Referring to FIG. 4a, a prior art concept of the imperative programming paradigm is shown. Such a programming paradigm is difficult to develop, nearly impossible to maintain in many situations, and has difficult to read code because of the use of conditional and unconditional branching statements (e.g., goto-type operations). Shown in FIG. 4b is the prior art concept of the structured programming paradigm, with easily readable code having clear entry and exit points, relatively easy maintainability, but without the ability to reuse internal structures. Shown in FIG. 4c is the prior art concept of the object oriented programming (“OOP”) paradigm, with its reusable code, but without a transparent architecture because of similar goto-type problems (e.g., ability of objects to perform ad-hoc calls of other objects) at an architectural level and with inherent difficulties in management and maintenance of the code.

Referring to FIG. 4d, an information system 70 programmed using the method and system of implementing COP of the present invention is shown. A configuration 72 is shown containing a plurality of nodes 74. Because the information system 70 is implemented by mapping the specified needs to the configuration 72 using a top-down approach, the configuration 72 may have a transparent architecture, may have reusable structures, and may allow for easy maintenance and easy knowledge management.

### EXEMPLARY INFORMATION SYSTEM IMPLEMENTED USING THE SYSTEM AND METHOD OF THE PRESENT INVENTION

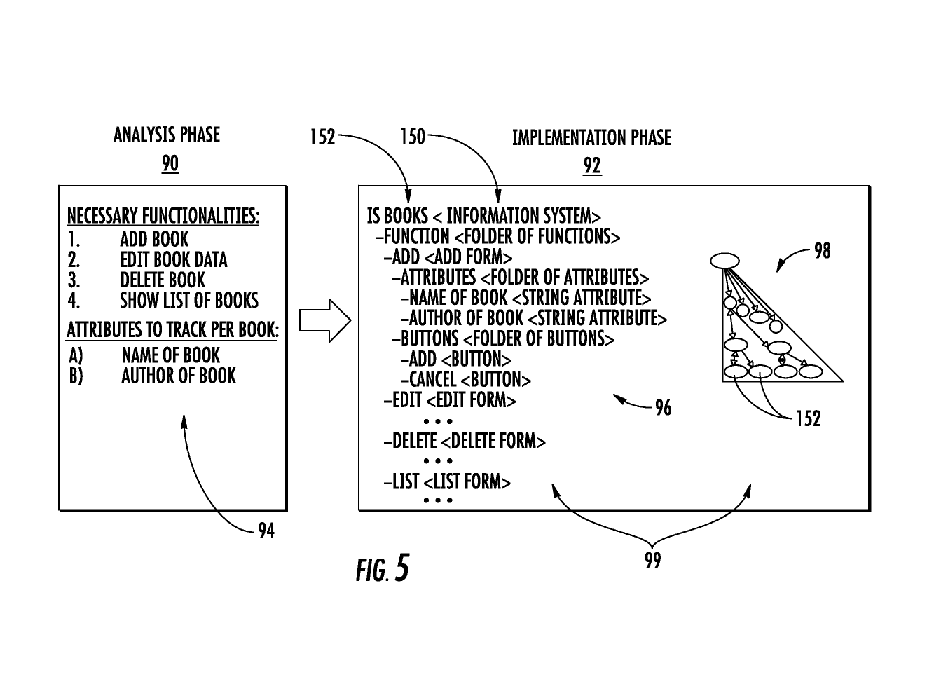

In a first example shown in FIGS. 5-7, a book records information system 100 is shown. It shall be understood that the term “IS” may be used herein as an abbreviated form of “information system.” In a top-down Analysis Phase 90, specific needs 94 are determined for the book records information system 100. In the example shown, the specific needs 94 include:

Necessary Functionalities:
1. Add book
2. Edit Book Data
3. Delete Book
4. Show List of Books

Attributes to Track Per Book:
a) Name of Book
b) Author of Book

Referring to FIG. 5, both a textual representation 96 and a graphical representation 98 of the configuration 99 are shown. As the specific needs 94 are determined, they may be mapped directly to the configuration 99 in an Implementation Phase 92.

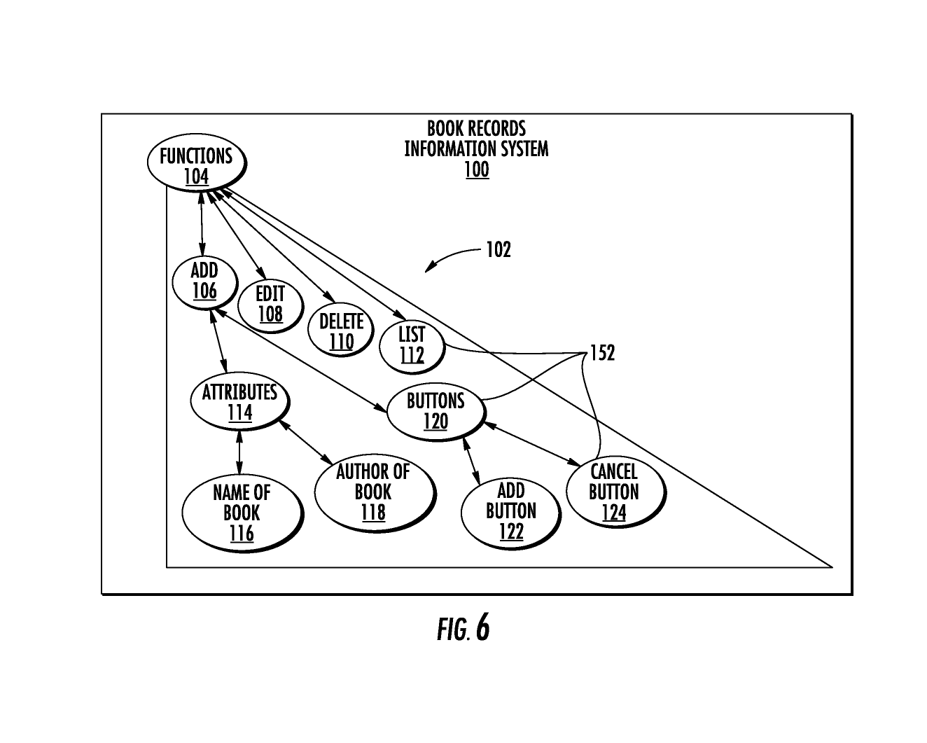

During the Implementation Phase 92, a number of nodes 152 are set up that correspond to the mapping of the specific needs 94. Referring to FIG. 6, the book records information system 100 contains a functions node 104, which itself links to four child nodes, specifically an add node 106, an edit node 108, a delete node 110, and a list node 112.

Continuing with implementing the book records information system 100 based on the specified needs determined in the analysis phase, the add node 106 may itself contain an attributes node 114 that further contains a name of book node 116 and an author of book node 118. The add node 106 may also contain a buttons node 120, which itself may contain an add button node 122 and a cancel button node 124.

It will be understood by those having skill in the art that the various other nodes, such as the edit node 108, the delete node 110, and the list node 112 may each themselves have additional child nodes. It will be further understood by those having skill in the art that the book records information system 100 may be implemented using numerous additional nodes. Thus, the number and type of nodes, as well as their relationships with other nodes, are not limited.

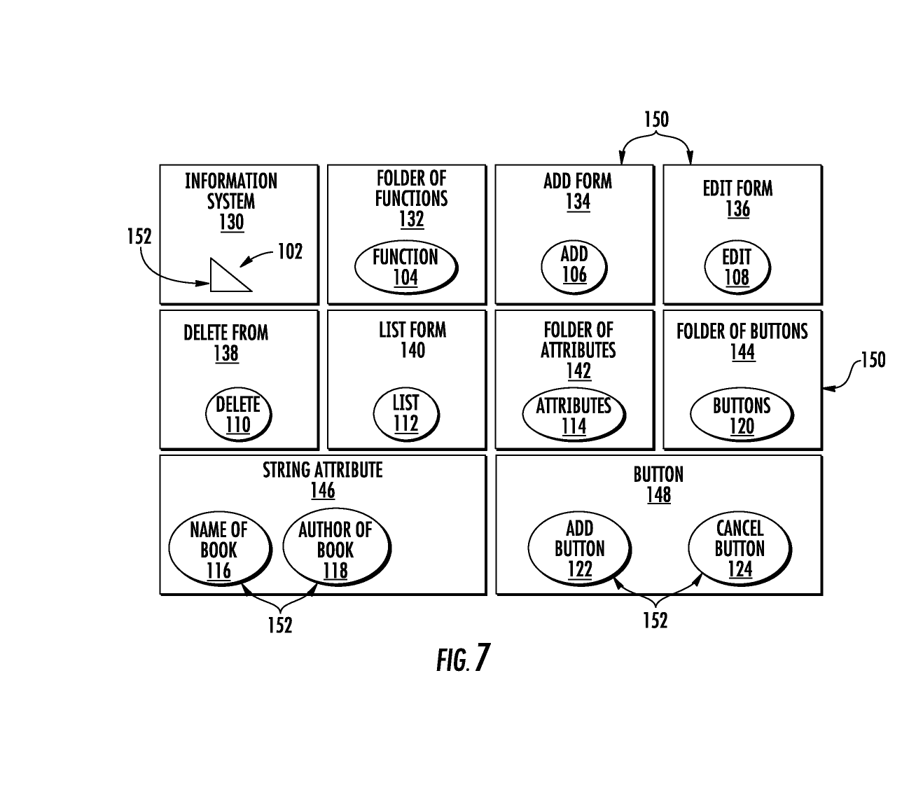

The configuration 102 itself and any nodes 152 contained within may be assigned node types 150. Nodes 152 with similar expected behavior will be designated as nodes of the same type. Referring to FIGS. 6-7, in the example of a book records information system 100, the configuration 102 itself is an <information system> type 130. The function node 104 may be a <folder of functions> type 132. The add node 106 may be an <add form> type 134, the edit node 108 may be an <edit form> type 136, the delete node 110 may be a <delete form> type 138, the list node 112 may be a <list form> type 140. The attributes node 114 may be a <folder of attributes> type 142, the name of book node 116 may be a <string attribute> type 146, the author of book node 118 may be another <string attribute> type 146, the buttons node 120 may be a <folder of buttons> type 144, the add button node 122 may be a <button> type 148, and the cancel button node 124 may be another <button> type 148. It will be understood to one having skill in the art that additional child nodes not depicted in this example may be implemented and defined as one of the aforementioned node types 150 or any new node type.

Each node type 150 may be individually implemented to perform differently. In this way, every node defined as a particular node type will behave according to the implementation of that particular node type.

In the example of a book records information system 100, examples of node types 150 may be implemented as follows:
The <information system> type 130 may be implemented with an executable method that selects the respective function from the folder of functions based on the function type called and calls the executable method for that function.
The <folder of functions> type 132 may have no methods and may have no internal implementation, but may rather be used only as an organizational concept for mapping the specified needs identified in the analysis phase to the configuration.
The <add form> type 134 may be implemented with an executable method that calls the attribute modules and the tailor module, so that they can draw themselves. The tailor module dresses the items in the proper visual presentation. The <add form> type 134 may be implemented such that if an event is detected, it calls an appropriate method to process the event (e.g., adding of a book).
The <edit form> type 136, <delete form> type 138, and <list form> type 140 may all be implemented with similar executable methods as that of the <add form> type 134, but each implemented to perform their required functions.
The <folder of attributes> type 142 may be implemented with an executable method that calls the executable method gradually on the attributes defined as its attributes (e.g., name of book node 116 and author of book node 118).
The <string attribute> type 146 may be implemented with an executable method that generates the code for storing and displaying one string attribute.
The <folder of buttons> type 144 may be implemented with an executable method that calls the executable method gradually on the buttons defined as its buttons (e.g., add button node 122 and cancel button node 124).
The <button> type 148 may be implemented with an executable method that generates the code for displaying and interacting with a button.

As described above and referring to FIGS. 5-7, the specified needs 94 of the book records information system 100 are mapped directly to the configuration 99 of an information system implemented in COP. Every node 152 in the configuration 99 is implemented through the implementation of its designated node type 150. In this fashion, the entire information system becomes easy to interpret and modify.

When an information system is implemented in the disclosed fashion and using COP, modifications to the information system become relatively easy.

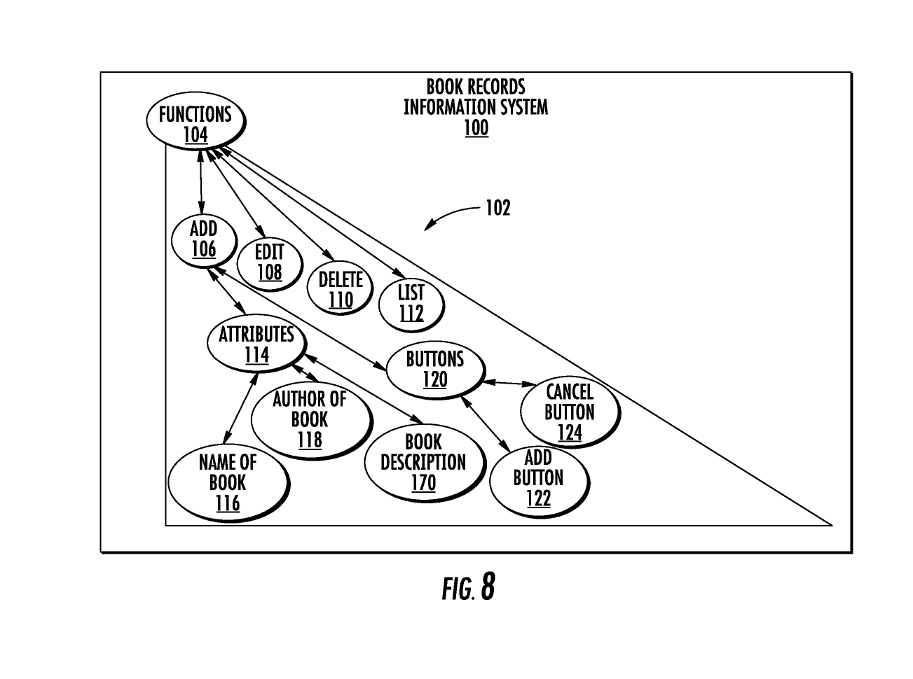

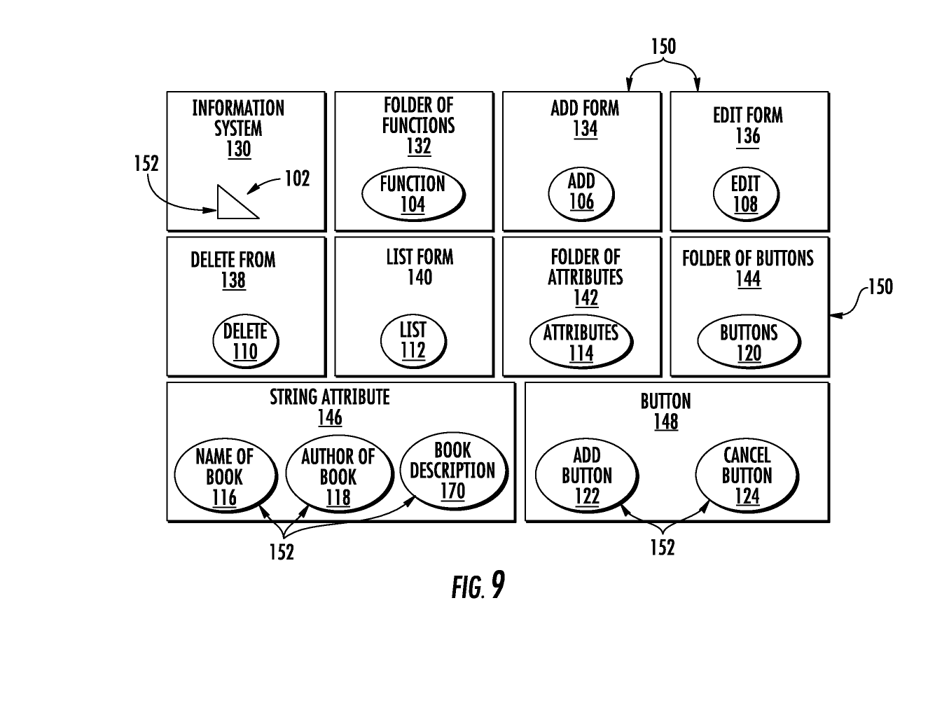

In the example of a book records information system 100, if one wished to add an additional attribute that is desired to be tracked, one simply adds the additional attribute to the configuration 102. Referring to FIGS. 8-9, one can add the ability for the book records information system 100 to keep track of the descriptions of books in its system by simply adding a book description node 170 to the configuration 102 and identifying it as a <string attribute> type 146. New code does not need to be implemented and original code does not need to be re-implemented, rather the configuration 102 simply needs to be updated. By updating the configuration 102 in this way, the changes are easily applied and are transparent.

Additionally, changes in the implementation of node types 150 can be performed easily. In an embodiment, a change or update to a single node type 150 may optionally cause every node 152 defined as that node type 150 to be automatically updated seamlessly. For example, in order to update how the book records information system 100 displays buttons, one would simply need to update the implementation of the <button> type 148 and the changes will cause all buttons defined as that node type (i.e., the add button and the cancel button) to be updated.

In many embodiments, a final information system can be implemented and improved through fine-tuning of the configuration, introduction of module types, and method implementation, such as shown in the above example.

In the example above, if the information system was instead implemented using the Model-View-Controller (“MVC”) design paradigm (e.g., the Spring framework), the specific needs identified in the Analysis Phase would be distributed into three sections during the Design and Implementation phases: 1) a model section (data section of the information system), 2) a view section (the presentation section of the information system), and 3) a controller section (control section of the information system). Using such an MVC design paradigm, any changes that need to be applied to the information system would need to be implemented across all three sections. Additionally, if one wishes to use elements from one information system in a different, but similar information system, transporting those elements from one MVC information system to another MVC information system will require transporting elements from all three sections, rather than transporting a single element. Furthermore, the use of the MVC design paradigm results in non-transparent links (e.g., links hidden in the code of objects) between the three sections of the information system's implementation.

Several methods for implementing information systems allowing process control for corporate information systems have been developed. The first extended method is Business Process Execution Language (“BPEL”) and SOA architecture. In this method, the composition-process choreography/orchestration is defined by BPEL workflows to which front-end SOA services are connected. In this approach, process implementation is artificially decomposed, which makes process sustainability and re-usability significantly more complicated (analogous with the MVC pattern and form processing). Another method is the application of the workflow framework, the disadvantage of which is low variability and limited options of how to add proprietary functionalities and properties to such workflows.

Mapping analysis concepts directly on the configuration provides significant cost savings in implementing information systems and, to an even greater degree, in maintaining them. Additionally, such an approach allows for the information system to be created much earlier in the process, including synchronously with an Analysis Phase.

Direct mapping through natural prototyping (i.e., gradual information system implementation depending on how concepts and functional specifications in the Analysis phase are identified), saves financial resources. Information system creators can see, in early phases of development, how the information system will be implemented. Because of this understanding by creators, there is a better analysis of user needs and bugs that may occur in the Analysis phase can be eliminated quickly, without waiting until the full information system has been put into operation. Methods of creating information systems based on iteration-incrimination strive to eliminate such Analysis phase errors, but those information system creation methods require high re-implementation costs for legacy parts of information systems, because of their use of “Bottom-Up” design. Such methods of creating information systems based on iteration-incrimination lack any direct mapping of the “Top-Down” analysis.

Direct concept mapping of the method and system for implementing information systems of the present invention brings even more benefits during information system maintenance. As the demands placed on information systems change in the majority of cases, particularly when the conditions of use change, the information systems need to be maintained and adjusted to match current user requirements. For example, in Enterprise Resource Planning (ERP) systems, demands placed on the information systems may change often and the need of quick and easy maintenance and updates are necessary. In another example, information systems that simply run for long periods of time may require quick and easy maintenance and updates. In instances where quick and easy maintenance and/or updating are necessary, mapping needs directly onto a configuration as described herein may substantially improve the efficiency of implementing new requirements due to the clear and transparent structure of the information system. Also, when minor changes to the Analysis occurs in an information system implemented using the system and method of the present invention, there is a reduced need to re-implement large portions of the information system in order to accommodate that minor change as compared to an information system implemented using prior art methods. In such an example, an information system can be maintained, updated, or re-created simply by making small changes to either the configuration and/or the node types. Such is not the case for information systems implemented through OOP where implementation associations, caused by mutual object calling, are created among objects if the “Top-Down” method is changed to “Bottom-Up”.

Based on experience and as compared to systems implemented through OOP, savings of up to 80% are achieved in information system implementation and of over 90% in subsequent operation for information system implemented using the system and method for implementing information systems of the present invention.

### SYSTEM FOR IMPLEMENTING INFORMATION SYSTEMS

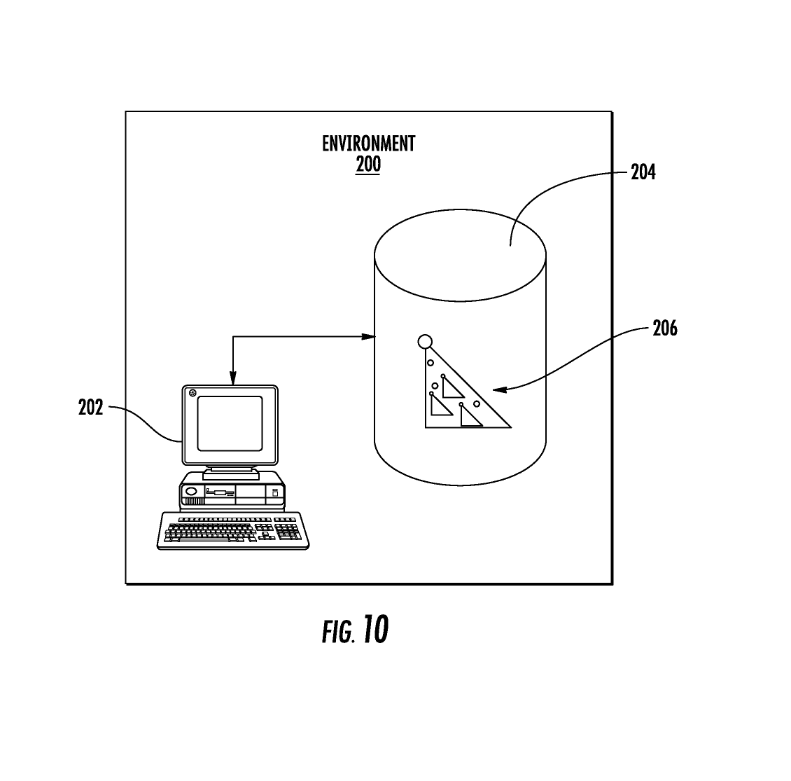

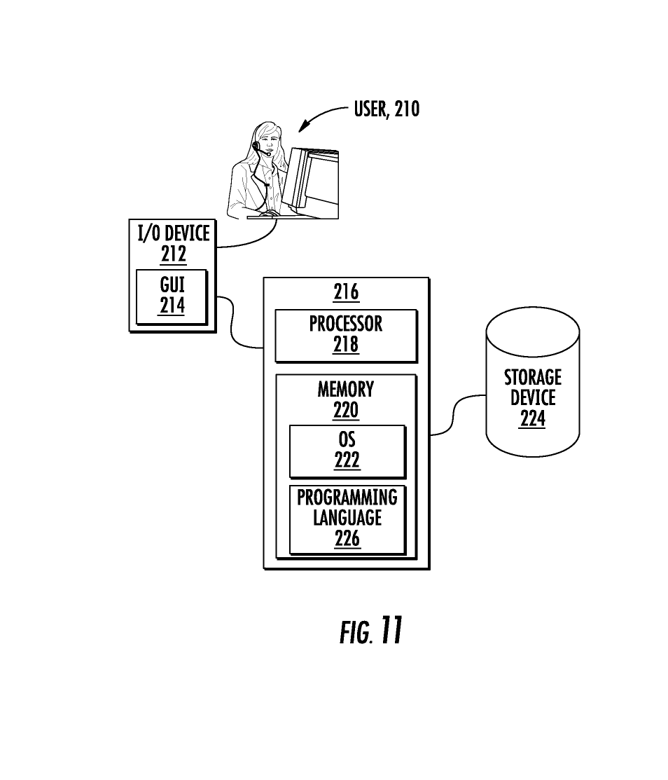

Referring to FIG. 10, the method and system of the present invention may be housed in an environment 200 that includes a system 202 communicatively linked to a storage device 204 containing a configuration 206. In an embodiment, as shown in FIG. 11, the system 216 includes processor 218, memory 220, and storage device 224. Memory 220 includes an operating system (OS) 222 such as Microsoft Windows, Mac OS, or Linux, and a programming language 226. System 216 also includes a link to an input/output (I/O) device 212 for display of information to a user 210. The display of information may take the form of a graphical user interface (GUI) 214.

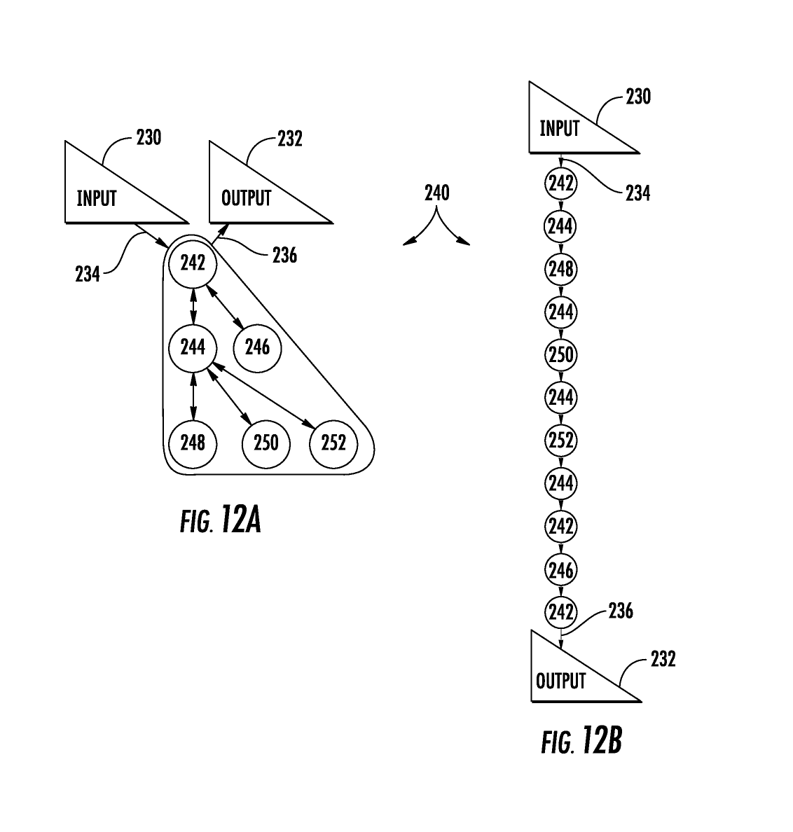

Referring to FIG. 12a, a configuration 240 may have a hierarchy that includes a top module 242, a first second-tier module 244, a second second-tier module 246, a first third-tier module 248, a second third-tier module 250, and a third third-tier module 252. As used herein, the ordinal and tiered module description language (e.g., “first second-tier” and “third third-tier”) used herein is used solely for the purpose of more easily describing and referring to modules within a particular embodiment of the invention, and are not to be construed in a limiting sense. The hierarchy may be referred to as a parent-child hierarchy where the modules further down as seen in the configuration 240 in FIG. 12a are “children” of the “parent” modules 242 further up in the configuration 240 in FIG. 12a. In other words, the top module 242 is a parent of both the first second-tier module 244 and the second second-tier module 246, which are both children of the top module 242. As well, the first second-tier module 244 is a “sibling” of the second second-tier module 246.

The modules are processed and interact according to the hierarchy of their configuration 240. As shown in FIG. 12b, a module will interact with all of its children modules in the next ordinal tier (depicted in FIG. 12a as below the current tier and referred to herein as “below”) in sequential order (depicted in FIG. 12a as left to right) before the next sequential module in its own tier will be processed.

In the configuration 240 depicted in FIGS. 12a-b, an input 230 causes the top module 242 to begin processing, optionally with input information 234 passed from the input 230. Next, the first second-tier module 244 will be processed, which in turn results in the processing of the first third-tier module 248 and then the second third-tier module 250. After the children modules of the first second-tier module 244 finish processing, the first second-tier module 244 itself will finish processing and the top module 242 will continue to process, which will result in the second second-tier module 246 processing. Then, the third third-tier module 252 will process, which will result in the second second-tier module 246 finishing processing, which will result in the top module 242 finishing processing. The completion of the processing of the top module 242 may result in an output 254, optionally with output information 236 being passed to the output 232.

Through the method and system described above, information systems may be built with both coding modules and configuring structures. The Coding Modules may be technical and contain no functional knowledge of the information system. The Node Types mentioned above are implemented through coding modules while the Configuration Nodes themselves are implemented through Configuration Structures. The Configuration Structures may be entirely functional and do not require technical knowledge. This dichotomy allows for the separation of jobs in a production environment so individuals tasked with implementing the functional aspects of the information system can be directed to working on Configuration Structures, while those individuals with advanced technical experience can work on the Coding Modules. Such a dichotomy may lead to increased efficiencies and savings in that the time and work of the valuable, skilled technicians can be focused on only those tasks that require a high level of technical skill, and fewer skilled technicians may be necessary to finish completion of an information system, as much of the work can be completed by non-technical workers.

In certain embodiments, the information system is built on top of Java and the COP runtime is written in Java. In this way, the information system may run on any operating system capable of running Java.

### PLATFORM FOR IMPLEMENTING INFORMATION SYSTEMS

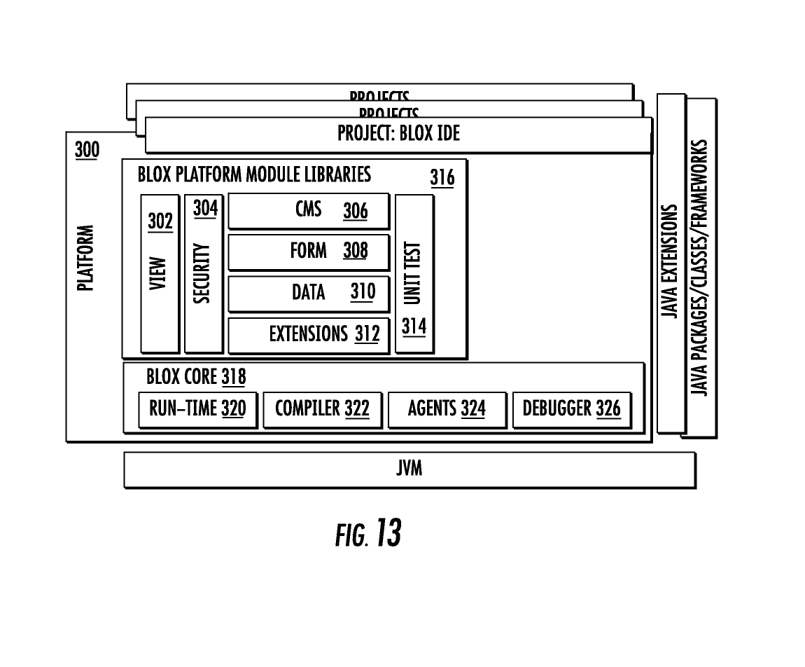

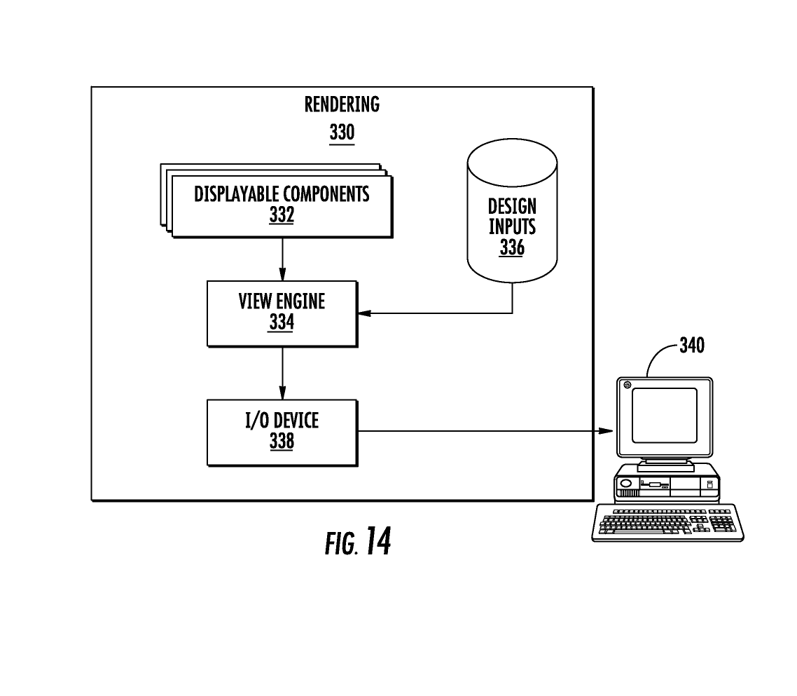

A platform for implementing information systems as described above is herein disclosed. As shown in FIG. 13, the Platform 300 can be categorized into seven logical layers. The View Layer 302 is responsible for graphically visualizing components from other layers based on a visual design or theme. As shown in FIG. 14, during rendering 330, a view engine 334 goes through all displayable components 332 that need to be displayed and graphically styles them according to selected design inputs 336 and sends them to be ultimately displayed on the system 340 by the I/O device 338.

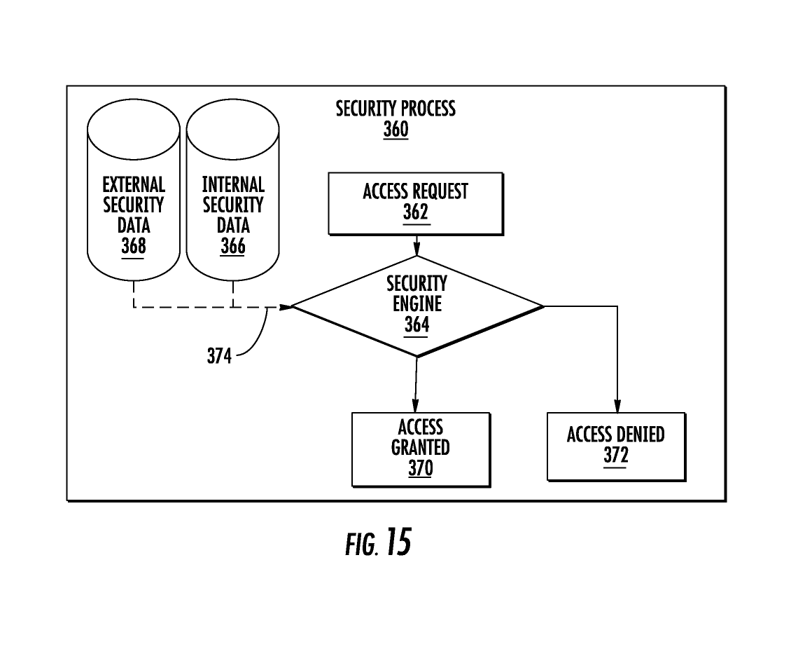

Referring back to FIG. 13, the security layer 304 contains components for enabling security through other layers. As shown in FIG. 15, during a security process 360, an access request 362 is reviewed by the security engine 364. The security engine 364 will use security data 374 from an internal security data source 366, an external security data source 368, or a combination of the two, in order to determine whether the access request 362 will be granted 370 or denied 372. The internal security data source 366 may include information contained within modules of the security layer 304. The external security data source 368 may include information from other modules outside of the security layer 304 or other external information sources on different systems or storage medium. The security data 374 may include credentialing information, including information about users, user roles, and access components. The access request 362 may include information about the user, the time of access, the components for which access is request, or other information pertaining to the user requesting access, the type of access requested, the nature of the request, or other information.

In an information system implemented using prior art methods such as implementation through OOP, it is necessary to implement a security layer at beginning of the information system implementation process; a security layer cannot be easily added or modified towards the end of the information system implementation process. When implementing an information system using the system and method disclosed herein using COP, the security layer 304 may be added and/or modified even as late as at the end of the information system implementation process.

Referring back to FIGS. 13-14, a Form layer 308 is used to define reusable web form components and controls created from simpler controls. The structure of this layer is a combination of the Model-View pattern taken from the Model-View-Controller paradigm and the final output given to the View layer for actual presentation and graphics styling to be displayed, such as in a specific CMS (Content Management System) layer item.

The Data layer 310 contains items that deal with data manipulation components. These include database operations, such as create, read, update, and delete. It also handles the ability to use multiple databases and database products, such as Oracle, MySQL, and Microsoft SQL Server, and transparently supports abstracting their proprietary data types and the ability to map them to consistent types used by the Framework. This layer also supports the ability to handle connections to databases and files and supports the general management of various data sources.

The Extensions layer 312 is used to take advantage of external components such as those written in Java. These can be organized into database, Web Service and SOA helper objects. Some of these may be provided out of box in the Platform.

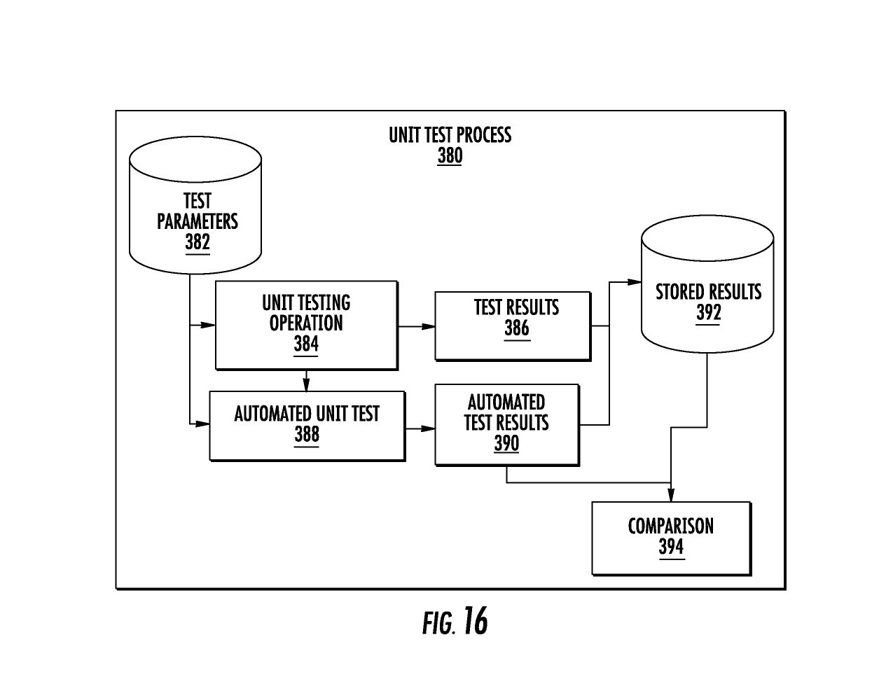

The Unit Test layer 314 provides for automated testing of projects. As shown in FIG. 16, a unit test process 380 is outlined. Pre-defined or user-defined Test Parameters 382 are input to a Unit Testing Operation 384, which outputs Test Results 386. These Test Results 386 may be stored as Stored Results 392. In certain embodiments and circumstances, the Test Parameters 382 may call for the Unit Testing Operation 384 to trigger additional Automated Unit Tests 388 that may occur repeatedly and with identical or different parameters, according to the Test Parameters 382. The Automated Unit Tests 388 produce their own Automated Test Results 390. The Automated Test Results 392 may themselves be stored as Stored Results 392. The Automated Test Results 390 may be compared with prior Stored Results 392 in a Comparison step 394. [01 02] Additionally, one or both of the Unit Testing Operation 384 or the Automated Unit Test 388 may occur against subparts of the information system 40, namely against one or more modules 44 or configurations 42. In other words, the Unit Test Layer 314 would provide functionality that initiates test cases and records test data for particular modules 44 or particular configurations 42. In this fashion, it is possible to initiate tests and record test data against subparts of the information system 40, independent of the user interface. The result is that the Unit Test Layer 314 of the proposed system and method for implementing information systems allows for regression tests of substructures of the information system 40 that enable automated regression testing of the entire information system 40 even while the information system 40 is being changed and updated to meet new or updated specification needs 32. Thus, automated testing of specific subparts of the information system 40 can maintain continuity despite changes to other parts of the information system 40.

As an example, the Unit Test Layer 314 can allow for automated testing of an invoicing process that can be conducted despite changes and updates to the information system's 40 user interface. As another example, the Unit Test Layer 314 can allow for automated testing of a security process that can be conducted despite changes and updates to the information system's 40 user interface. As another example, the Unit Test Layer 314 can allow for automated testing of an interface for communicating with other systems despite changes and updates to the information system's 40 user interface.

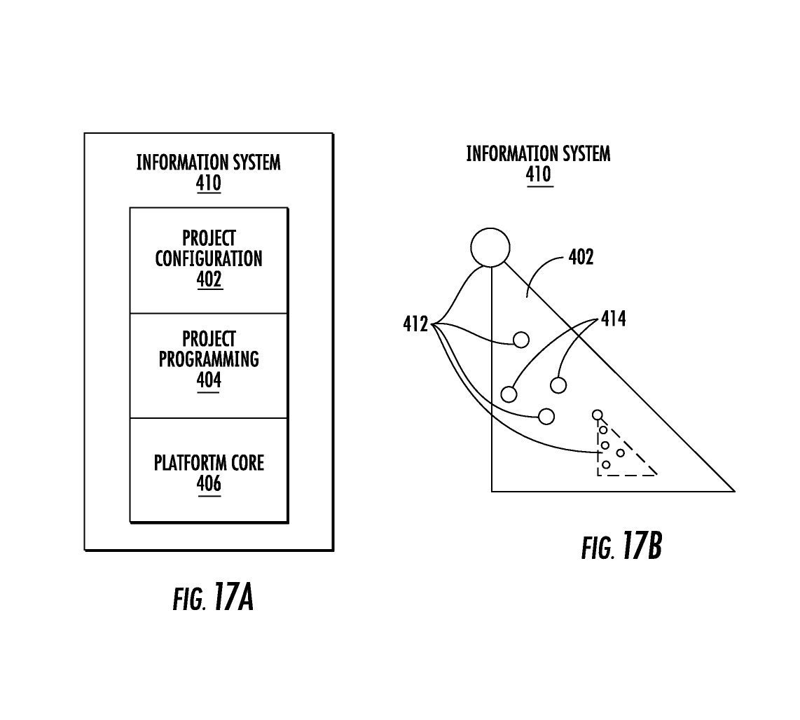

As shown in FIG. 17a, an information system 410 implemented using the Platform described above may include a Project Configuration 402, Project Programming 404, and a Platform Core 406. FIG. 17b shows a graphical representation of an embodiment of the exemplary information system 410 implemented using the Platform 300. Referring to FIGS. 17a-17b, the Platform Core 406 may include one or more core modules 412 available for use across any information system implemented using the Platform. Every core module 412 need not be used. These core modules 412 may be read-only by creators of the information system 410 and may be extensible by the creator of the Platform 400. The Project Programming 404 may include project/corporation specific coding and detailed definitions of the behavior of the modules. As such, the Project Programming 404 may include programming for project-specific node types. Further, the Project Programming 404 may include project-specific modules 414. The Project Configuration 402 is the project-specific configuration layer, containing no technical programming, but rather functional relationships and the like.

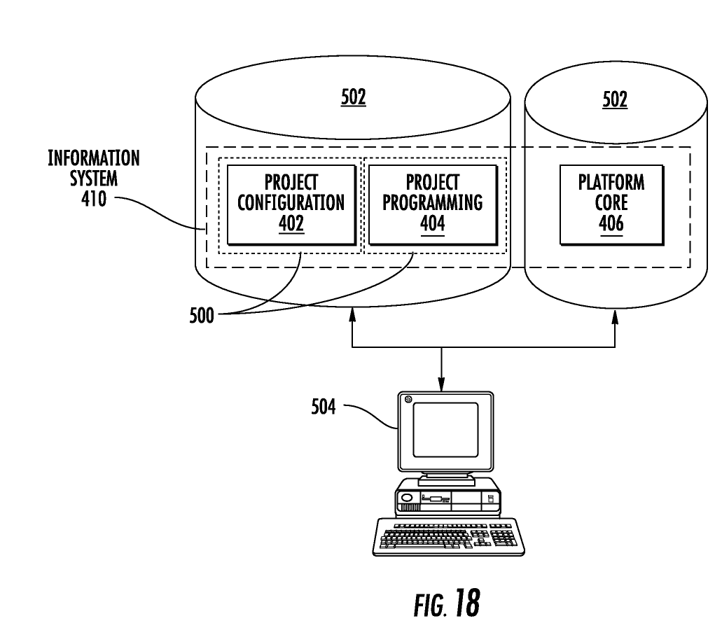

Referring to FIG. 18, each of the Project Configuration 402, Project Programming 404, and Platform Core 406 may be stored in one or more storage units 500 within one or more storage devices 502. A processor 504 may be connected to the one or more storage devices 502 to interact with the information system 410. One or more of the storage devices 502 may be located at a location remote to the processor 504.

It will be understood that using the system and method for implementing information systems, as described herein, one may create full, clear, and transparent information systems in minimal time by creating a Project Configuration 402 that takes advantage of core modules 412 and any necessary Project Programming 404.

The headings used in this description are inserted for readability purposes only and are not to be construed as limiting, in any way, the contents of this disclosure.

While the invention has been described in conjunction with specific exemplary implementations, it is evident to those skilled in the art that many alternatives, modifications, and variations will be apparent in light of the foregoing description. The invention is intended to embrace all such alternatives, modifications, and variations that fall within the scope and spirit of the appended claims.

What is claimed is:

1. A method of implementing an information system using configuration-oriented programming, comprising:
identifying a specification need for the information system,
mapping the specification need to a configuration in a substantially top-down manner.

2. The method of claim 1, wherein the specification need is one of a physical object and an aspect of a physical object.

3. The method of claim 2, wherein the information system tracks a set of data regarding the one of a physical object and an aspect of a physical object.

4. The method of claim 1, wherein the identifying is performed in a substantially top-down manner.

5. The method of claim 1, wherein the configuration contains one or more configuration nodes and the mapping includes assigning one or more node types to a configuration node.

6. The method of claim 5, wherein each of the one or more node types contains a programming and wherein the identifying and mapping are performed without requiring technical knowledge of the programming of the one or more node types.

7. The method of claim 1, additionally comprising:
repeating the identifying and mapping for one or more additional specification needs, and wherein the mapping includes establishing one or more relationships between a first configuration node and one or more second configuration nodes.

8. The method of claim 7, wherein the mapping includes:
assigning one or more node types to each of the first configuration node and the one or more second configuration nodes.

9. The method of claim 8 additionally comprising:
creating a visual representation of the implementation of the information system indicating each of the first configuration node and the one or more second configuration nodes, indicating each of the one or more relationships, and indicating each of the one or more node types.

10. The method of claim 9, wherein the visual representation is one of a textual representation and a graphical representation.

11. The method of claim 9, wherein each of the one or more node types contains a programming and wherein the identifying and mapping are performed without requiring technical knowledge of the programming of the one or more node types.

12. The method of claim 7, additionally comprising:
creating a visual representation of the implementation of the information system indicating each of the first configuration node and the one or more second configuration nodes and indicating each of the one or more relationships.

13. The method of claim 12, wherein the visual representation is one of a textual representation and a graphical representation.

14. An environment for implementing an information system using configuration-oriented programming, comprising:
one or more data storage devices having a first data storage unit having stored thereon a configuration, the configuration containing one or more configuration nodes in a hierarchy wherein one or more specification needs have been mapped, in a top-down approach, to the one or more configuration nodes; and
a processor communicatively linked to the one or more data storage devices and capable of processing the one or more configuration nodes of the configuration according to the hierarchy.

15. The environment of claim 14,
wherein the one or more data storage devices additionally comprises a second data storage unit having stored thereon one or more coding modules, each of the one or more coding modules having a programming,
wherein the one or more configuration nodes each relate to at least one of the one or more coding modules, and
wherein the processor processes each of the one or more configuration nodes based on the programming of any related one or more coding modules.

16. The environment for implementing an information system of claim 15, additionally comprising an input/output device communicatively linked to the processor and capable of altering the configuration.

17. The environment for implementing an information system of claim 15, wherein at least one of the one or more specification needs represents one of a physical object, an aspect of a physical object, and a relationship between a plurality of physical objects.

18. A method of implementing an information system using the environment of claim 17, comprising:
identifying a set of desired functions of a desired information system;
creating the configuration at least in part by mapping each of the set of desired function to the one or more configuration nodes;
using the information system;
receiving feedback relating to a change to be made in the information system; and
altering the configuration to incorporate the change without altering the programming of the one or more coding modules.

19. A method of implementing an information system using configuration-oriented programming, comprising:
identifying a specification need for the information system;
creating project programming, including at least one node type;
mapping the specification need to a project configuration in a substantially top-down manner, the project configuration having one or more configuration nodes;
assigning the at least one node type to the one or more configuration nodes; and
associating at least one of the project configuration and the project programming to a platform core.

20. An environment for implementing the information system of claim 19, comprising:
one or more data storage devices having at least one first data storage unit having stored thereon the project configuration, the project programming, and the platform core, wherein the project configuration has a hierarchy; and
a processor communicatively linked to the one or more data storage devices and capable of processing the one or more configuration nodes of the configuration according to the hierarchy.
